(19) United States
(12) Patent Application Publication
(10) Pub. No.: US 2018/0225685 A1
(43) Pub. Date: Aug. 9, 2018

(54) IDENTIFYING IMPENDING USER-COMPETITOR RELATIONSHIPS ON AN ONLINE SOCIAL NETWORKING SYSTEM

(71) Applicant: LinkedIn Corporation, Sunnyvale, CA (US)

(72) Inventor: Ho jeong Kim, Belmont, CA (US)

(21) Appl. No.: 15/426,487

(22) Filed: Feb. 7, 2017

(51) Int. Cl. G06Q 30/02; G06Q 50/00; G06Q 10/06; G06N 7/00

(52) U.S. Cl. CPC G06Q 30/0202; G06N 7/005; G06Q 10/067; G06Q 50/01

(57) ABSTRACT

An online social networking system receives a first set of data associated with activities between its members and its competitors. The system uses the first set of data to develop and train propensity models to predict when the members and the competitors are likely to establish a business relationship. The system tests the propensity models to determine a best propensity model and selects that best propensity model. The system receives a second set of data associated with activities between a particular member and particular competitor. The system uses the best propensity model for predicting when the particular member and the particular competitor are likely to establish a business relationship based on the second set of data, and transmits an electronic message to the particular member relating to the business relationship between the particular member and the particular competitor.

### TECHNICAL FIELD

The present disclosure generally relates to the technical field of online social networking services, and in an embodiment, but not by way of limitation, to an online social networking system that can identify impending user-competitor relationships on the online social networking system.

### BACKGROUND

Online social networks provide their members or users the ability to connect and communicate with other members or users of the online social network. Online social networks include a personal profile for each member, which includes the educational history, work history, and personal interests of the member.

An employee advocacy application is an application that permits employees to promote the companies that they work for, especially through online social networks. In many instances, such employee advocacy applications, such as LinkedIn's Elevate, is a business to business (B2B) product. Such employee advocacy applications can be used by companies to select content that the companies would like their employees to share. In some instances, the employees download an Android or iOS app, or use their desktop, to access the employee advocacy application. At this point, the employees can share the information that was selected by their respective companies. Specifically, such content can be shared via social media outlets such as LinkedIn, Facebook, and Twitter.

These employee advocacy applications permit companies to reach people that they normally do not have direct access to. For example, people who follow the company's page may be a much smaller network than the connections of their employees' networks. Additionally, companies in general feel that it is a lot more authentic when an employee who someone knows is sharing something about the employee's company, as compared to simply receiving a generic advertisement from the company. From the employees' point of view, many employees want to share quality content so as to establish and maintain their reputation. However, not every employee has the time to search for quality content to share with others. However, if the employee's company has an employee advocacy program, the employees can then locate quality content to share with not too much effort.

### DESCRIPTION OF THE DRAWINGS

Some embodiments are illustrated by way of example and not limitation in the accompanying drawings, in which:

FIG. 1 is a block diagram of the functional modules or components that comprise a computer network-based online social networking system, including application server modules consistent with some embodiments of the invention;

FIG. 2 is a block diagram depicting some example application server modules of FIG. 1;

FIGS. 3A and 3B are a flow diagram of an example embodiment of a process wherein an online social networking system can identify its competitors using the resources of the online social networking system; and

FIG. 4 is a block diagram of a machine in the form of a computing device within which a set of instructions may be executed for causing the machine to perform any one or more of the methodologies discussed herein.

### DETAILED DESCRIPTION

In the following description, for purposes of explanation, numerous specific details are set forth in order to provide a thorough understanding of the various aspects of different embodiments of the present invention. It will be evident, however, to one skilled in the art that the present inventive subject matter may be practiced without all of the specific details and/or with variations, permutations, and combinations of the various features and elements described herein.

An embodiment relates to an online social networking system's ability to use data on the online social networking system to identify its competitors, and to approach its members, customers, clients, and/or other users before they establish a business relationship with those competitors. If this is possible, then the online social networking system can sell its products and services to its users before its competitors do. For example, if the online social networking system has an employee advocacy product, the online social networking system can identify users who may want to use this employee advocacy product, and can identify such users before the users approach a competitor of the online social networking system for the same or similar product. That is, the online social networking system can identify the users, members, and/or companies to which the online social networking system should try to sell its products or services.

The online social networking system can analyze data associated with activities between its users and its competitors on the online social networking system in order to identify potential customers of its products and services. More specifically, an embodiment of the present disclosure identifies competitors with whom users of the online social networking system may be in the process of establishing a business relationship. Consequently, a unique feature of the present disclosure is the realization that the online social networking system has competitors, that these competitors use certain aspects of the online social networking system, and that the online social networking system can identify relationships between its users and these competitors. For example, these competitors of the online social networking system may like to share content on the online social networking system via an employee advocacy service. The online social networking system then has at its disposal which users and competitors are engaging in activities with each other.

If a particular user, for example a company-customer of the online social networking system, is using a competitor of the online social networking system, and that company-customer posts something on the online social networking system, then as noted the online social networking system knows about and has access to that data. Consequently, the online social networking system then knows that this particular company-customer is either using its competitor or contemplating using its competitor. This is a signal that the company-customer is not purchasing the products or services of the online social networking system. Or, even if the company-customer is trying the services of the online social networking system, the company-customer is not purchasing the services of the online social networking system, but perhaps purchasing the products and services from the competitor. These data or signals are unique to the online social networking system. That is, while the online social networking system and its competitors may compete in certain products and services, such as an employee advocacy product, because the competitor in some way uses the online social networking system to promote or deploy its competing service, the online social networking system has access to these data. These data and signals are very unique to the online social networking system. With these data, the online social networking system can identify which company-customers are already trying out a competitor of the online social networking system.

However, as one can surmise, once the company-customer has already used the competitor, it is probably too late for the online social networking system to sell its product or service to this company-customer because the company-customer has probably already either signed a deal with the competitor or the customer is almost ready to sign a deal with the competitor. Consequently, it would be beneficial for the online social networking system to be able to predict which customers are in the process of building relationships with competitors, before these relationships progress too far and the potential customer is lost. That is, the online social networking system would like to identify the process of establishing a relationship before the customer and the competitor actually consummate a deal.

By using application program interface (API) data, the online social networking system can determine if the potential company-customer is already using the competitor's product or service. If the company-customer is already using the competitor's product or service, it is of course too late for the online social networking system to try to sell that product or service to the potential company-customer. However, the online social networking system has a history of API data, along with activity data showing activity between the potential customer and the competitor. The online social networking system can use these data, and in particular the activity data, to its advantage. Specifically, with this historical activity data, the online social networking system can develop a model to predict what kind of data indicates that a potential company-customer is considering purchasing a product or service from a competitor. Some of these past data metrics include the number of connections between the potential customer and the competitor, the number of connections with the competitor initiated by the customer, the page views of the competitor's pages by the customer, the content of the profiles of the customer and the competitor, whether the customer is following the competitor company and/or looking at the competitor's pages on the online social networking system, and electronic message exchanges between the potential customer and the competitor's employees on the online social networking system. All of these data can indicate that the customer and competitor are starting to build a relationship. From these metrics, a correlation can be determined. Thereafter, the online social networking system can train a model to predict the customers who are already working with a competitor, and the customers who are likely to sign up with a competitor at some point in the future. For the customers who are likely to sign up with a competitor, the online social networking system can reach out to the potential customer before they actually sign the deal, and can introduce the potential customer to the products and services of the online social networking system.

These activity data can be analyzed during different time periods, which can be referred to as a hold period, a first time period, and a second time period. The hold period is used to predict that a company-customer is going to use the competitor and when the company-customer actually uses the competitor. So, in cases in which the company-customer actually did use the competitor by a certain date, the online social networking system looks at what is referred to as the hold-out time, that is for example, about 2-4 weeks after the first activity usage data between the customer and the competitor appeared. The online social networking system looks at the behavior of the company-customer during this hold-out time, and in the future, can identify this behavior in other company-customers and determine whether or not there is still time to reach out to these other company-customers.

In an embodiment, the first time period is about 60 to 90 days before the hold--out period, and the second time period two is about 60 to 90 days before the first time period. The functions of the first time period and the second time period are to see the changes in the building of the relationship between the company-customer and the competitor, such as via an increase in electronic message traffic between them.

A propensity model is developed using the typical processes of model development. For example, a decision tree or random forest could be used to compare very different kinds of models to test in order to see which one works better. As is well known in the art, one uses a training example to develop a model. After developing the models, one then compares the different models to determine whether, for random points, a linear regression or a neural network works better. Then for the model that works better, different data samples are used to tune the algorithm. Specifically, a validation sample is used to tune parameters once the system model that is to be used is selected. Then, the test sample is applied to see the performance of the model. The performance of the model is the ability to determine whether a particular company-customer and a particular competitor are establishing a relationship, and then providing this information to the proper people within the social networking system so that such people can approach the company-customer before a deal is established between the company-customer and the competitor.

While as discussed above, the online social networking system would like to determine whether a company-customer is beginning a relationship with a competitor, in another embodiment, the online social networking system would like to determine which of its customers are ready for a particular product or service of the online social networking system, irrespective of whether that company-customer is initiating a relationship with a competitor or not. This embodiment can be thought of as more a targeting of company-customers. In such an embodiment, past activity data of customers and the relationship of that data to future purchases of products and services are modeled, and then those models are used to analyze current activity data of current potential customers to try to predict whether a particular customer would be receptive to the purchase of a particular product or service. In this embodiment, after target customers are identified, a feature of the online social networking system could be to identify which of these target customers is more likely to use a competitor, using the methods disclosed herein.

Additionally, when targeting a customer, other metrics such as the type of industry, the company size, the company location, how many sales people the target customer has, and how many marketing people the target customer has, could be used. The targeted customer embodiment works well in situations wherein the online social networking system does not really have a competitor for a particular product or service, so the relationship between the company-customer and competitor cannot be used.

One or more embodiments can be used to differentiate between, in the prediction analysis, a company-customer that is just thinking about using a competitor product or service versus a company-customer that is actually going to take action on a competitor product or service. This embodiment is primarily sales-based, that is, which competitor is trying to reach out to try to sell a product or service to a company-customer, and make sure that company-customer knows about the products or services of the online social networking system. For one situation, the focus of the online social networking system can be on one company-customer because the online social networking system knows that the company-customer is already talking to a competitor.

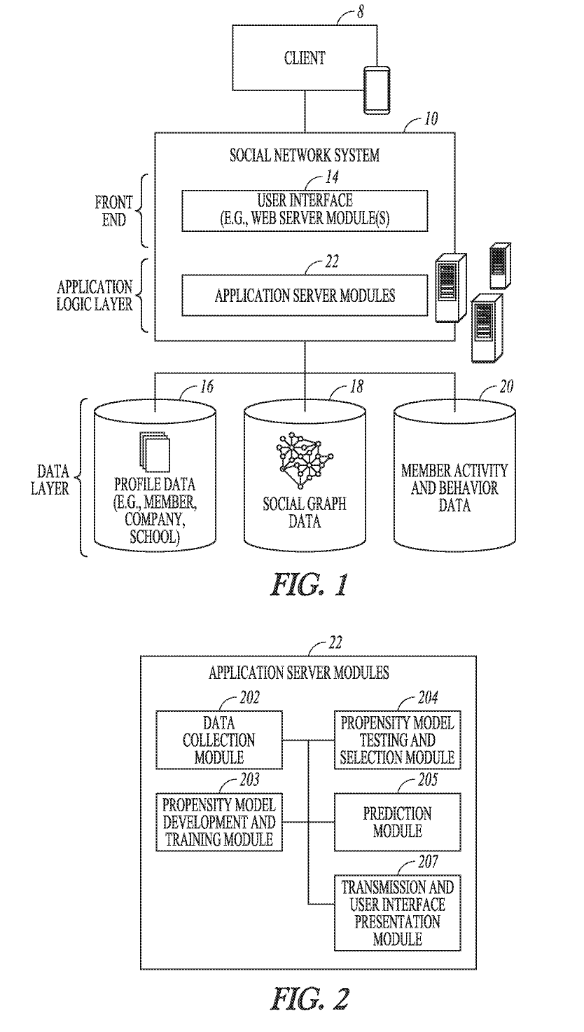

Referring now to the drawings, FIG. 1 is a block diagram of the functional modules or components that comprise a computer-based or network-based online social networking system 10 consistent with some embodiments of the invention. As shown in FIG. 1, the online social networking system 10 is generally based on a three-tiered architecture, comprising a front-end layer, application logic layer, and data layer, and can communicate with a client device 8. As is understood by skilled artisans in the relevant computer and Internet-related arts, each module or engine shown in FIG. 1 represents a set of executable software instructions and the corresponding hardware (e.g., memory and processor) for executing the instructions. To avoid obscuring the present subject matter with unnecessary details, various functional modules and engines that are not germane to conveying an understanding of the present subject matter have been omitted from FIG. 1. However, a skilled artisan will readily recognize that various additional functional modules and engines may be used with an online social networking system, such as that illustrated in FIG. 1, to facilitate additional functionality that is not specifically described herein. Furthermore, the various functional modules and engines depicted in FIG. 1 may reside on a single server computer, or may be distributed across several server computers in various arrangements. Moreover, although depicted in FIG. 1 as a three-tiered architecture, the present subject matter is by no means limited to such architecture.

As shown in FIG. 1, the front end comprises a user interface module (e.g., a web server) 14, which receives requests from various client-computing devices, and communicates appropriate responses to the requesting client devices. For example, the user interface module(s) 14 may receive requests in the form of Hypertext Transport Protocol (HTTP) requests, or other web-based, application programming interface (API) requests. The client devices may be executing conventional web browser applications, or applications that have been developed for a specific platform to include any of a wide variety of mobile devices and operating systems.

As shown in FIG. 1, the data layer includes several databases, including one or more databases 16 for storing data relating to various entities represented in a social graph. With some embodiments, these entities include members, companies, and/or educational institutions, among possible others. Consistent with some embodiments, when a person initially registers to become a member of the online social networking system 10, and at various times subsequent to initially registering, the person will be prompted to provide some personal information, such as his or her name, age (e.g., birth date), gender, interests, contact information, home town, address, the names of the member's spouse and/or family members, educational background (e.g., schools, majors, etc.), current job title, job description, industry, employment history, skills, professional organizations, and so on. This information is stored as part of a member's profile, for example, in the database with reference number 16. With some embodiments, a member's profile data will include not only the explicitly provided data, but also any number of derived or computed member profile attributes and/or characteristics.

Once registered, a member may invite other members, or be invited by other members, to connect via the online social networking system 10. A “connection” may require a bi-lateral agreement by the members, such that both members acknowledge the establishment of the connection. The degree of connectivity refers to the amount or number of connections that exist for a particular person and/or the amount or number of connections among a group of persons. Similarly, with some embodiments, a member may elect to “follow” another member. In contrast to establishing a “connection”, the concept of “following” another member typically is a unilateral operation, and at least with some embodiments, does not require acknowledgement or approval by the member that is being followed. When one member follows another, the member who is following may receive automatic notifications about various activities undertaken by the member being followed. In addition to following another member, a user may elect to follow a company, a topic, a conversation, or some other entity. In general, the associations and relationships that a member has with other members and other entities (e.g., companies, schools, etc.) become part of the social graph data maintained in a database 18. With some embodiments a social graph data structure may be implemented with a graph database 18, which is a particular type of database that uses graph structures with nodes, edges, and properties to represent and store data. in this case, the social graph data stored in database 18 reflects the various entities that are part of the social graph, as well as how those entities are related with one another.

With various alternative embodiments, any number of other entities might be included in the social graph, and as such, various other databases may be used to store data corresponding with other entities. For example, although not shown in FIG. 1, consistent with some embodiments, the system may include additional databases for storing information relating to a wide variety of entities, such as information concerning various online or offline groups, job listings or postings, photographs, audio or video files, and so forth.

With some embodiments, the online social networking system 10 may include one or more activity and/or event tracking modules, which generally detect various user-related activities and/or events, and then store information relating to those activities/events in the database with reference number 20. For example, the tracking modules may identify when a user makes a change to some attribute of his or her member profile, or adds a new attribute. Additionally, a tracking module may detect the interactions that a member has with different types of content. Such information may be used, for example, by one or more recommendation engines to tailor the content presented to a particular member, and generally to tailor the user experience for a particular member.

The application logic layer includes various application server modules 22, which, in conjunction with the user interface module(s) 14, generate various user interfaces (e.g., web pages) with data retrieved from various data sources in the data layer. With some embodiments, individual application server modules 22 are used to implement the functionality associated with various applications, services and features of the online social networking system 10. For instance, a messaging application, such as an email application, an instant messaging application., or some hybrid or variation of the two, may be implemented with one or more application server modules 22. Of course, other applications or services may be separately embodied in their own application server modules 22.

The online social networking system 10 may provide a broad range of applications and services that allow members the opportunity to share and receive information, often customized to the interests of the member. For example, with some embodiments, the online social networking system 10 may include a photo sharing application that allows members to upload and share photos with other members. As such, at least with some embodiments, a photograph may be a property or entity included within a social graph. With some embodiments, members of an online social networking system may be able to self-organize into groups, or interest groups, organized around a subject matter or topic of interest. Accordingly, the data for a group may be stored in a database. When a member joins a group, his or her membership in the group will be reflected in the social graph data stored in the database with reference number 18. With some embodiments, members may subscribe to or join groups affiliated with one or more companies. For instance, with some embodiments, members of the online social networking system 10 may indicate an affiliation with a company at which they are employed, such that news and events pertaining to the company are automatically communicated to the members. With some embodiments, members may be allowed to subscribe to receive information concerning companies other than the company with which they are employed. Here again, membership in a group, a subscription or following relationship with a company or group, as well as an employment relationship with a company, are all examples of the different types of relationships that may exist between different entities, as defined by the social graph and modeled with the social graph data of the database 18.

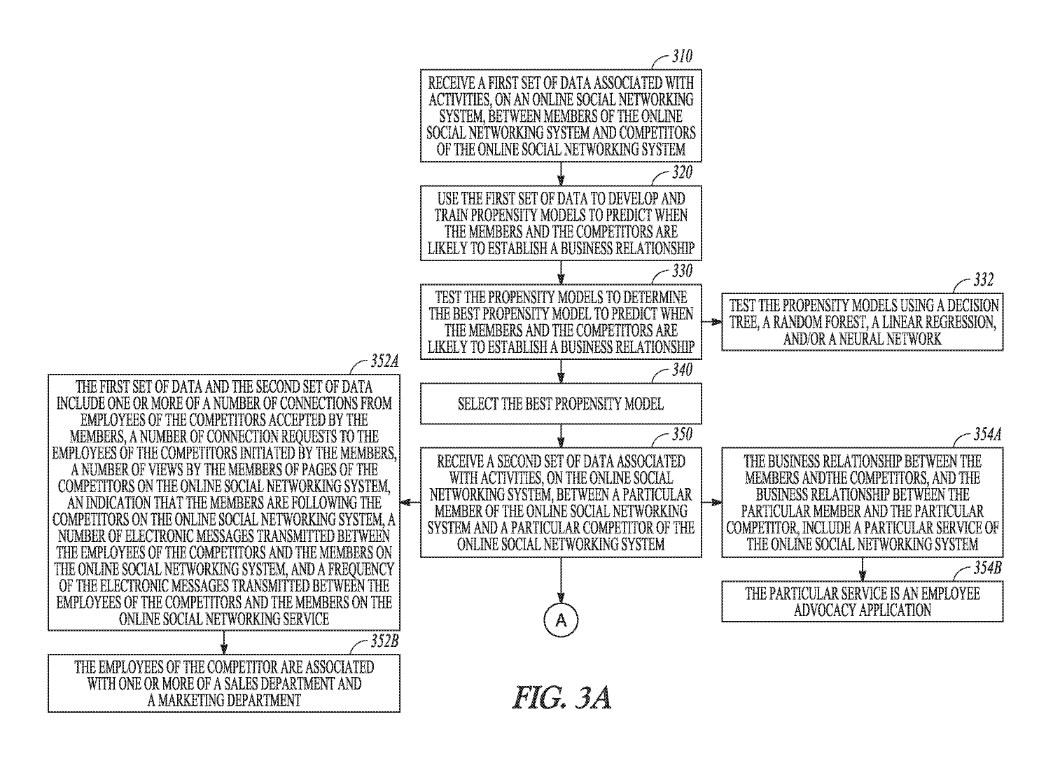

FIG. 2 is a block diagram depicting some example application server modules 22 of FIG. 1. A data collection module 202 may be configured to collect and/or receive, for example, sets of data associated with activities on a social networking system between users of an online social networking system and competitors of the online social networking system. Other data that can be collected by the data collection module 202 include profile data, behavior data, endorsement data, online social networking system data, occupational data, and connectivity data.

A propensity model development and training module 203 can develop and train propensity models that are used to predict when the users and competitors of the online social networking system are likely to establish a business relationship. A propensity model testing and selection module 204 can test the propensity models to determine the best propensity model for predicting when the members and the competitors are likely to establish a business relationship, and then can select the best propensity model. A prediction module 205 can predict when a particular user and a particular competitor are likely to establish a business relationship, including a date when such relationship is likely to be established. A transmission and user interface presentation module 207 can transmit an electronic message to a particular member relating to the business relationship between the particular member and the particular competitor, and can generate a user interface for presentation to the user.

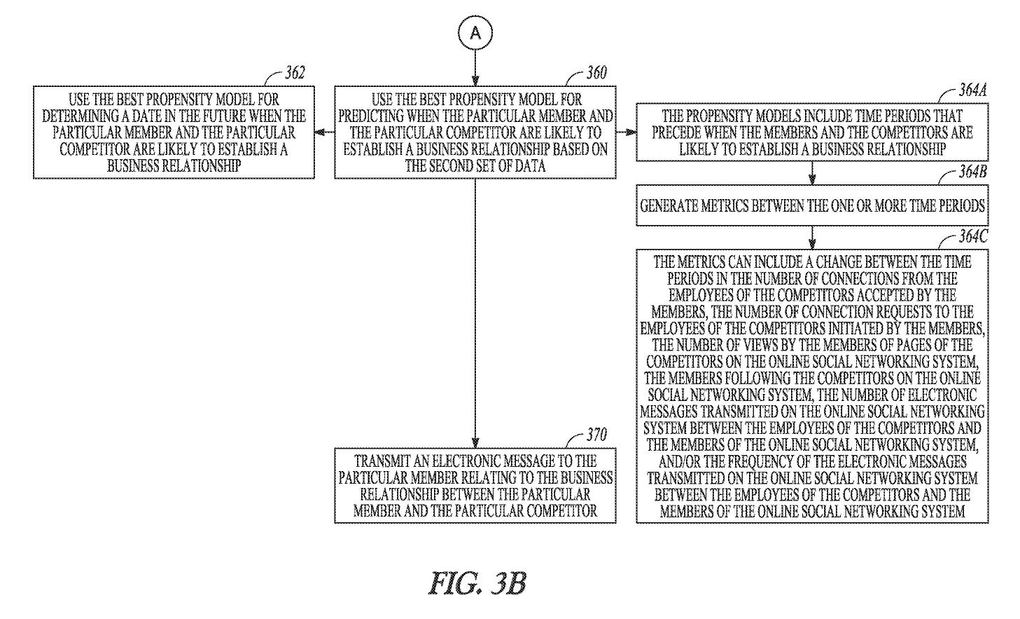

FIGS. 3A-3B are a flow diagram illustrating an example method of an online social networking system using activity data between a user, such as a particular company-customer, and a competitor of the online social networking system, to determine if the company-customer and the competitor are likely to establish a business relationship. As noted in the previous paragraph, in various embodiments, the method may be implemented by one or more of the modules or processors of FIG. 2. FIGS. 3A-3B include a number of process blocks 310-370, Though arranged somewhat serially in the example of FIGS. 3A-3B, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

At 310, the online social networking system receives a first set of data associated with activities, on the online social networking system, between users, members, or customers of the online social networking system and competitors of the online social networking system. The users can be considered as customers of products or services of the online social networking system, and can be individual customers or business entities or companies. At 320, the online social networking system uses the first set of data to develop and train one or more propensity models to predict when the users and the competitors are likely to establish a business relationship.

At 330, the online social networking system tests the one or more propensity models to determine the best propensity model to predict when the users and the competitors are likely to establish a business relationship. At 332, the online social networking system tests the one or more propensity models using, as is known to those of skill in the art, one or more of a decision tree, a random forest, a linear regression, and a neural network. At 340, the online social networking system selects the best propensity model.

In the modeling operation, the prediction module 205 performs a prediction modeling process based on the activity data between users of the online social networking system and competitors of the online social networking system. According to various exemplary embodiments described in more detail below, the aforementioned prediction (or propensity) modeling process may include using propensity model development and training module 203 to generate a prediction model (e.g., a logistics regression model) based on the activity data. Thereafter, the trained prediction model can analyze the activity data of a particular user of the online social network service to predict whether that user is likely to establish a business relationship with a competitor of the online social networking system. For example, the trained prediction model may be utilized to determine whether the behaviour of the particular user matches or conforms to the historical activity data. This may then be repeated for any user of the online social networking system, in order to identify other users of the online social network system who may be establishing a relationship with a competitor.

The prediction module 205 can use any one of various known prediction modeling techniques to perform the prediction modeling. For example, according to various exemplary embodiments, the prediction module 205 may apply a statistics-based machine learning model such as a logistic regression model to the activity data. As understood by those skilled in the art, logistic regression is an example of a statistics-based machine learning technique that uses a logistic function. The logistic function is based on a variable, referred to as a logit. The logit is defined in terms of a set of regression coefficients of corresponding independent predictor variables. Logistic regression can be used to predict the probability of occurrence of an event given a set of independent/predictor variables. A highly simplified example machine learning model using logistic regression may be ln[p/(1−p)]=a+BX+e, or [p/(1−p)]=exp(a+BX+e), where ln is the natural logarithm, logₑₓₚ, where exp=2.71828 . . . , p is the probability that the event Y occurs, p(Y=1), p/(1−p) is the “odds ratio”, ln[p/(1−p)] is the log odds ratio, or “logit”, a is the coefficient on the constant term, B is the regression coefficient(s) on the independent/predictor variable(s). X is the independent/predictor variable(s), and e is the error term. In some embodiments, the independent/predictor variables of the logistic regression model may be activity data associated with users of an online social network service (where the activity data may be encoded into feature vectors). The regression coefficients may be estimated using maximum likelihood or learned through a supervised learning technique from the activity data, as described in more detail below.

Accordingly, once the appropriate regression coefficients (e.g., B) are determined, the features included in a feature vector (e.g., activity data associated with a user of a social network system) may be plugged in to the logistic egression model in order to predict the probability that the event Y occurs (where the event Y may be, for example, a particular user of an online social network system likely forming a business relationship with a competitor). In other words, provided a feature vector including various activity features associated with a particular user, the feature vector may be applied to a logistic regression model to determine the probability that the particular user is likely to form a business relationship with a competitor. Logistic regression is well understood by those skilled in the art, and will not be described in further detail herein, in order to avoid occluding various aspects of this disclosure. The prediction module 205 can use various other prediction modeling techniques understood by those skilled in the art to predict whether a particular user is likely to form a business relationship with a competitor. For example, other prediction modeling techniques can include other machine learning models such as a Naïve Bayes model, a support vector machines (SVM) model, a decision trees model, and a neural network model, all of which are understood by those skilled in the art.

According to various embodiments described above, the activity data can be used for purposes of both off-line training (for generating, training, and refining a prediction model and/or the coefficients of a prediction model) and online inferences (for predicting whether a particular user is likely to establish a business relationship with a competitor). For example, if the prediction module 205 is utilizing a logistic regression model (as described above), then the regression coefficients of the logistic regression model may be learned through a supervised learning technique from the activity data. Accordingly, in one embodiment, the prediction module 205 can operate in an off-line training mode by assembling the activity data into feature vectors. (For the purposes of training the system, the system generally needs both positive examples of activity data wherein a user and a competitor entered into a business relationship, as well as negative examples of activity wherein a user and a competitor did not enter into a business relationship). The feature vectors may then be passed to the prediction module 205, in order to refine regression coefficients for the logistic regression model. For example, statistical learning based on the Alternating Direction Method of Multipliers technique may be utilized for this task. Thereafter, once the regression coefficients are determined, the prediction module 205 can operate to perform online (or offline) inferences based on the trained model (including the trained model coefficients) on a feature vector representing the activity of a particular user of the online social network system. For example, according to various exemplary embodiments described herein, the prediction module 205 is configured to predict the likelihood that a user will establish a business relationship with a competitor, based on whether the activity of the particular user on the online social networking system matches or conforms to the activity data that was utilized to train the model. In some embodiments, if the probability that the particular user will establish a business relationship with a competitor is greater than a specific threshold (e.g., 0.5, 0.8, etc.), then the prediction module 205 can classify that particular user as likely to establish a business relationship with a competitor. In other embodiments, the prediction module 205 may calculate an activity score for the particular user, based on the probability that the particular user is likely to establish a business relationship with a competitor. Accordingly, the prediction module 205 can repeat this process for other users of an online social network system.

According to various exemplary embodiments, the off-line process of training the prediction module 205 based on the activity data may be performed periodically at regular time intervals (e.g., once a month or once every six months), or may be performed at irregular time intervals, random time intervals, continuously, etc. Thus, since activity data can change over time based on changes in the activity of the users and competitors, it is understood that the prediction module 205 itself can change over time (based on the current activity data being used to train the model). The activity of users establishing business relationships with competitors can change over time because, for example, industry practices can change, or features, products and technology of the online social network system can change, and so on.

Non-limiting examples of activities representative of users likely to establish a business relationship with a competitor (e.g., the positive examples described above) can include transmitting or receiving a particular number of electronic messages to the competitor on the online social networking system, viewing a particular amount of profiles of employees of the competitor, performing a particular number of searches on the online social networking system for employees of the competitor, and so on. Of course, such activities are merely exemplary, and the activity data identified by the prediction module 205 can change continuously as the ecosystem of the online social network system evolves over time.

Returning to FIGS. 3A and 3B, at 350, the online social networking system receives a second set of data associated with activities, on the online social networking system, between a particular user of the online social networking system and a particular competitor of the online social networking system. In an embodiment, as indicated at 352A, the first set of data and the second set of data include one or more of a number of connections from employees of the competitors accepted by the users, a number of connection requests to the employees of the competitors initiated by the users, a number of views by the users of pages of the competitors on the online social networking system, an indication that the users are following the competitors on the online social networking system, a number of electronic messages transmitted between the employees of the competitors and the users on the online social networking system, and a frequency of the electronic messages transmitted between the employees of the competitors and the users on the online social networking system. As indicated at 352B, in a particular embodiment, the employees of the competitor are associated with one or more of a sales department and a marketing department. Employees of a sales department or a marketing department may be a better indicator of an impending business relationship then perhaps employees of an engineering or software department. As indicated at 354A, the business relationship between the members and the competitors, and the business relationship between the particular member and the particular competitor, include a particular service of the online social networking system. For example, as indicated at 354B, the particular service could be an employee advocacy application.

At 360, the online social networking system uses the best propensity model for predicting when the particular user and the particular competitor are likely to establish a business relationship based on the second set of data. At 362, the online social networking system uses the best propensity model for determining a date in the future when the particular user and the particular competitor are likely to establish a business relationship. As noted at 364A, the one or more propensity models (including the selected propensity model) include one or more time periods that precede when the users and the competitors are likely to establish a business relationship. At 364B, the online social networking system generates metrics between the one or more time periods. As indicated at 364C, the metrics can include a change between the time periods in one or more of the number of connections from the employees of the competitors accepted by the users, the number of connection requests to the employees of the competitors initiated by the users, the number of views by the users of pages of the competitors on the online social networking system, the number of users following the competitors on the online social networking system, the number of electronic messages transmitted on the online social networking system between the employees of the competitors and the users of the online social networking system, and the frequency of the electronic messages transmitted on the online social networking system between the employees of the competitors and the users of the online social networking system.

At 370, the online social networking system transmits an electronic message to the particular user relating to the business relationship between the particular user and the particular competitor. This electronic message could be an attempt to offer to the user a product or service of the online social networking system before the user establishes a business relationship with the competitor of the online social networking system for that product or service. The online social networking system can also display the electronic message on a computer display unit or device.

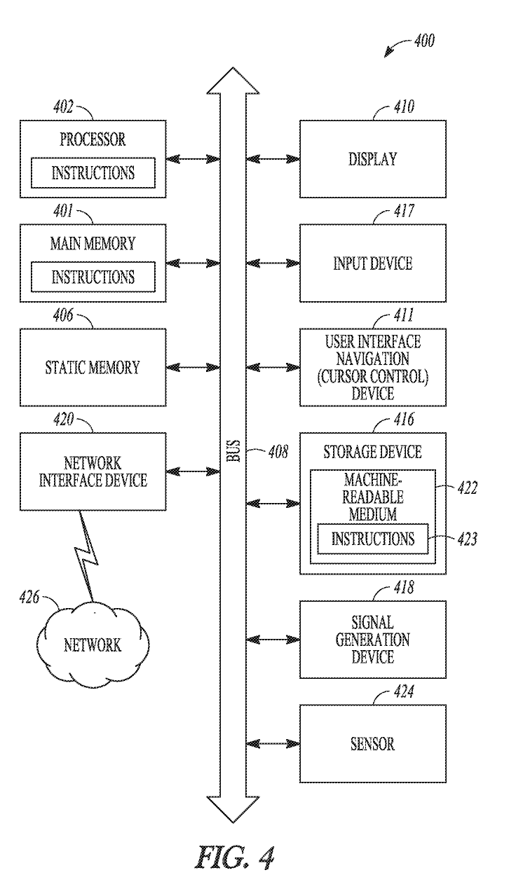

FIG. 4 is a block diagram of a machine in the form of a computer system 400 within which a set of instructions 423 may be executed for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer; however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor 402 (e.g., a central processing unit (CPU), a graphics processing unit (GPU) or both), a main memory 401 and a static memory 406, which communicate with each other via a bus 408. The computer system 400 may further include a display unit 410, an alphanumeric input device 417 (e.g., a keyboard), and a user interface (UI) navigation device 411 (e.g., a mouse). In one embodiment, the display, input device and cursor control device are a touch screen display. The computer system 400 may additionally include a storage device 416 (e.g., drive unit), a signal generation device 418 (e.g., a speaker), a network interface device 420, and one or more sensors 424, such as a global positioning system sensor, compass, accelerometer, or other sensor.

The storage device 416 includes a machine-readable medium 422 on which is stored one or more sets of data structures and instructions 423 (e.g., software) embodying or utilized by any one or more of the methodologies or functions described herein. The instructions 423 may also reside, completely or at least partially, within the main memory 401 and/or within the processor 402 during execution thereof by the computer system 400, the main memory 401 and the processor 402 also constituting machine-readable media.

While the machine-readable medium 422 is illustrated in an example embodiment to be a medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 423 may further be transmitted or received over a communications network 426 using a transmission medium via the network interface device 420 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although embodiments have been described with reference to specific examples, it will be evident that various modifications and changes may be made to these embodiments without departing from the broader scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

1. A system comprising:
a computer-readable medium having instructions stored thereon, which, when executed by a processor, cause the system to:
receive a first set of data associated with activities, on an online social networking service, between members of the online social networking service and competitors of the online social networking service;
use the first set of data to develop and train one or more propensity models to predict when the members and the competitors are likely to establish a business relationship;
test the one or more propensity models to determine a best propensity model to predict when the members and the competitors are likely to establish a business relationship;
select the best propensity model;
receive a second set of data associated with activities, on the online social networking service, between a particular member of the online social networking service and a particular competitor of the online social networking service;
use the best propensity model for predicting when the particular member and the particular competitor are likely to establish a business relationship based on the second set of data; and
transmit an electronic message to the particular member relating to the business relationship between the particular member and the particular competitor.

2. The system of claim 1, wherein the one or more propensity models are tested using one or more of a decision tree, a random forest, a linear regression, and a neural network.

3. The system of claim 1, wherein the business relationship between the members and the competitors, and the business relationship between the particular member and the particular competitor, comprises a particular service of the online social networking service.

4. The system of claim 3, wherein the particular service comprises an employee advocacy application.

5. The system of claim 1, wherein the first set of data and the second set of data comprise one or more of a number of connections from employees of the competitors that have been accepted by the members, a number of connection requests to the employees of the competitors initiated by the members, a number of views by the members of pages of the competitors on the online social networking service, an indication that the members are following the competitors on the online social networking service, a number of electronic messages transmitted between the employees of the competitors and the members on the online social networking service, and a frequency of the electronic messages transmitted between the employees of the competitors and the members on the online social networking service.

6. The system of claim 5, wherein the employees of the competitor comprise one or more of a sales department and a marketing department.

7. The system of claim 1, comprising determining, upon a detection of the second set of data, a date in the future when the particular member and the particular competitor are likely to establish a business relationship.

8. The system of claim 1, wherein the one or more propensity models comprise one or more time periods that precede when the members and the competitors are likely to establish a business relationship.

9. The system of claim 8, comprising generating metrics between the one or more time periods.

10. The system of claim 9, wherein the metrics comprise a change between the time periods in one or more of the number of connections from the employees of the competitors that have been accepted by the members, the number of connection requests to the employees of the competitors initiated by the members, the number of views by the members of pages of the competitors on the online social networking service, the members following the competitors on the online social networking service, the number of electronic messages transmitted between the employees of the competitors and the members on the online social networking service on the online social networking service, and the frequency of the electronic messages transmitted between the employees of the competitors and the members of the online social networking service on the online social networking service.

11. A process comprising:
receiving a first set of data associated with activities, on an online social networking service, between members of the online social networking service and competitors of the online social networking service;
using the first set of data to develop and train one or more propensity models to predict when the members and the competitors are likely to establish a business relationship;
testing the one or more propensity models to determine a best propensity model to predict when the members and the competitors are likely to establish a business relationship;
selecting the best propensity model;
receiving a second set of data associated with activities, on the online social networking service, between a particular member of the online social networking service and a particular competitor of the online social networking service;
using the best propensity model for predicting when the particular member and the particular competitor are likely to establish a business relationship based on the second set of data; and
transmitting an electronic message to the particular member relating to the business relationship between the particular member and the particular competitor.

12. The process of claim 11, wherein the one or more propensity models are tested using one or more of a decision tree, a random forest, a linear regression, and a neural network.

13. The process of claim 11, wherein the business relationship between the members and the competitors, and the business relationship between the particular member and the particular competitor, comprise a particular service of the online social networking service.

14. The process of claim 13, wherein the particular service comprises an employee advocacy application.

15. The process of claim 11, wherein the first set of data and the second set of data comprise one or more of a number of connections from employees of the competitors that have been accepted by the members, a number of connection requests to the employees of the competitors initiated by the members, a number of views by the members of pages of the competitors on the online social networking service, an indication that the members are following the competitors on the online social networking service, a number of electronic messages transmitted between the employees of the competitors and the members on the online social networking service, and a frequency of the electronic messages transmitted between the employees of the competitors and the members on the online social networking service.

16. The process of claim 15, wherein the employees of the competitor are associated with one or more of a sales department and a marketing department.

17. The process of claim 11, comprising determining, upon a detection of the second set of data, a date in the future when the particular member and the particular competitor are likely to establish a business relationship.

18. The process of claim 11, wherein the one or more propensity models comprise one or more time periods that precede when the members and the competitors are likely to establish a business relationship.

19. The process of claim 18, comprising generating metrics between the one or more time periods.

20. The process of claim 19, wherein the metrics comprise a change between the time periods in one or more of the number of connections from the employees of the competitors that have been accepted by the members, the number of connection requests to the employees of the competitors initiated by the members, the number of views by the members of pages of the competitors on the online social networking service, the members following the competitors on the online social networking service, the number of electronic messages transmitted between the employees of the competitors and the members on the online social networking service on the online social networking service, and the frequency of the electronic messages transmitted between the employees of the competitors and the members of the online social networking service on the online social networking service.
